(19) United States
(12) Patent Application Publication
(10) Pub. No.: US 2025/0334449 A1
(43) Pub. Date: Oct. 30, 2025

(54) GLASSES AND SHIELD FOR PHOSPHORESCENCE DETECTION AND METHOD

(71) Applicant: UV Lit Optical, LLC, Waco, TX (US)

(72) Inventor: Tonya C. Cybuski, Waco, TX (US)

(73) Assignee: UV Lit Optical, LLC, Waco, TX (US)

(21) Appl. No.: 19/192,648

(22) Filed: Apr. 29, 2025

Related U.S. Application Data
(60) Provisional application No. 63/640,352, filed on Apr. 30, 2024.

(51) Int. Cl. G01J 3/44; G01J 3/02

(52) U.S. Cl. CPC G01J 3/4406; G01J 3/0256; G01J 3/0262; G01J 3/0264; G01J 3/0283; G01J 3/0291

(57) ABSTRACT

The present invention comprises eyeglasses in combination with a UV light (UV Glasses) for hands-free ease of detection of fluorescent substances. The present invention also comprises a face shield in combination with a UV light (UV Face Shield). The UV Glasses and UV Face Shield are generally headwear devices that use the head to support the devices. One or more UV lights can be fixedly coupled to the eyeglasses or face shield and so configured to be synchronous with the wearer's head movement along with the wearer's vision to the area where the wearer is looking. In another embodiment, the UV light can be movably, including rotatably, coupled relative to the wearer's head movement in various planes to enable the wearer to adjust the area illuminated by the UV lights.

### CROSS REFERENCE TO RELATED APPLICATIONS

This application claims the benefit of U.S. Provisional Application Ser. No. 63/640,352, entitled “GLASSES AND SHIELD FOR PHOSPHORESCENCE DETECTION AND METHOD”, filed Apr. 30, 2024, and is incorporated herein by reference.

### STATEMENT REGARDING FEDERALLY SPONSORED RESEARCH OR DEVELOPMENT

Not applicable

### BACKGROUND OF THE INVENTION

### Field of the Invention

Applicant's invention relates to devices and use of UV light for detection of fluorescent substances. The method of Applicant's invention relates to the use of eyewear and headwear coupled with UV lights for detection of fluorescent substances.

### Background Information

A light in the ultraviolet (“UV”) spectrum is generally in the higher frequency spectrum than the visible spectrum and infrared light, which is even lower frequency at the opposite end of the spectrum. Because it is higher frequency, UV is considered a highly energetic light, but one which is generally considered harmless to humans at common intensities.

The visible light spectrum is created by electromagnetic radiation with wavelengths between 380 nanometers (nm) to 700 nm. Blue light rays are called high-energy visible lights, as they have the shortest wavelength of visible light ranging from 380 to 500 nm. We sometimes refer to them as blue-violet or violet lights. Ultra-violet (UV) light rays are just beyond the visible light spectrum.

As used herein, a “UV light” refers to a physical emitter that emits at least mostly high frequency, short wavelength UV light. Traditionally, there are various ways to create a UV light, such as to use a fluorescent tube. Another common method is to add a UV filter through which visible light travels. The filter, either on a bulb or placed in conjunction with the lamp housing, blocks most of the visible light and allows UV light through, so the lamp is a UV light.

There are three main forms of luminescence: fluorescence, phosphorescence and chemiluminescence. Fluorescence and phosphorescence are two forms of photoluminescence. In photoluminescence, a substance's glow is triggered by light, in contrast to chemiluminescence, where the glow is caused by a chemical reaction. Both fluorescence and phosphorescence are based on the ability of a substance to absorb light and emit light that has a longer wavelength and lower energy. The main difference between fluorescence and phosphorescence is the time in which it takes to absorb and emit the light. In fluorescence, the emission is basically immediate and therefore generally only visible, if the light source (such as UV lights) is continuously on the material; while phosphorescent material can store the absorbed light energy for some time and release light later, resulting in an afterglow that persists after the light has been switched off. Depending on the material, this afterglow can last anywhere from a few seconds to hours.

So generally, a fluorescent substance is a substance that emits visible light from the excitation of the fluorophores by ultraviolet light (photons). The fluorophore converts the energy in the UV radiation from a UV light into visible light. Fluorescent substances can absorb UV light and re-emit it at a different wavelength in the visible spectrum. Upon re-emission, the light is visible to human sight. The fluorescent substance can be viewed because the re-emitted light gives the fluorescent substance a glowing appearance.

In the process of fluorescence photoluminescence, an electron gains energy by absorption of a photon of a certain wavelength, such as in the UV spectrum. The electron relaxes to a lower energy state through a series of non-radiative transitions (vibrational relaxation and internal conversion). Further relaxation to ground state by fluorescence results in emission of a photon of lower energy and longer wavelength (converting UV light to visible light) than the exciting photon.

Many biological cells are fluorescent substances, such as body fluids (like urine, blood, vomit, and semen), insects, and arthropods. In fact, lightning bugs and other bioluminescent animals produce their glow from a chemical reaction. Scorpions and some relatives produce a blue-green glow via fluorescence. Under ultraviolet light, molecules in their exoskeleton absorb and re-emit UV as visible light. Some manufactured fluids are used in industry and fluoresce, such as those used in automobiles.

This characteristic of UV light has been taken advantage of, for example, to identify materials at crime scenes based on what materials contain these fluorescent substances. As stated, body fluids contain fluorescent molecules and are made visible using a UV light. Generally, it is important to have as little visible light emitted from the UV light as possible, because the visible light can drown out the fluorescence.

Eyeglasses, also known as spectacles, have lenses mounted in frames for wearing in front of a wearer's eyes to aid vision or to correct such defects of vision as myopia, hyperopia, and astigmatism. Eyeglasses are generally made of a frame that holds the lenses in place on the wearer's face. The frame will generally include rims or some other structure to which the lenses are coupled, a bridge that sits over the wearer's nose, and temples that are coupled to the ends of the rim and extend back over the wearer's ears to help keep the eyeglasses in place. Generally, the temples are parallel with the wear's sight, while the rims and lenses combination are perpendicular to the wearer's sight.

There are three (3) different types of eyeglasses: those with converging lenses, those with diverging lenses, and those with lenses that are parallel, neither converging nor diverging. The distance from the focus to the lens is called the focal length. Converging lenses are convex with a positive focal length and diverging lenses are concave with a negative focal length. Focal length is not stated directly in a prescription for eyeglasses. Instead, the refractive power is used to describe the extent to which a lens refracts light. The formula used to find the refractive power of the lens (in diopters) is the inverse of the focal length (in meters). This relationship shows that the greater the power of a lens, the shorter the focal length.

A magnifying lens consists of a single convex lens that magnifies an object when the lens is held in front of the object. Magnifying eyeglasses make objects appear larger because their convex lenses refract or bend light rays, so that they converge or come together.

### SUMMARY OF THE INVENTION

The present invention comprises eyeglasses in combination with a UV light (UV Glasses) for hands-free ease of detection of fluorescent substances. The present invention also comprises a face shield in combination with a UV light (UV Face Shield). The UV Glasses and UV Face Shield are generally headwear devices that use the head to support the devices. One or more UV lights can be fixedly coupled to the eyeglasses or face shield and so configured to be synchronous with the wearer's head movement along with the wearer's vision to the area where the wearer is looking. In another embodiment, the UV light can be movably, including rotatably, coupled relative to the wearer's head movement in various planes to enable the wearer to adjust the area illuminated by the UV lights.

In at least one embodiment, the UV lights can be coupled to a temple of the eyeglasses. In another embodiment, the UV lights can be coupled in an array on the face shield. The eyeglasses or face shield may have lenses with magnification, or no magnification. While certain wearers may choose not to use magnification, having magnifying lenses with a focal point generally at the same distance as desired by the wearer to view potential fluorescent substances can be helpful to the wearer to view and identify the fluorescent substances. For example, a focal length can be a distance, or range of distances, between six inches and ten feet or any distances inclusively between. The magnification lenses may be anywhere in the range of 1.0× to 20.0× magnification. The wearer can search for fluorescent substances hands free of the magnification (if desired) and of the UV light. In some embodiments, the lenses can be tinted to filter unwanted light during the UV light usage.

The method of the present invention comprises using the UV Glasses or UV Face Shield in the detection of selected materials using photoluminescence detection. The UV Glasses or UV Face Shield can be placed on the wearer's face generally in front of the wearer's eyes. The wearer can turn the UV light on using a switch to produce a UV light beam, or otherwise actuate the light via audio signals or by touchless technology, and the UV light follows the movement of the wearer's head. For movable embodiments, the wearer can adjust the orientation of the UV light so that the UV light beam is flexibly directed toward the area the wearer is viewing. The UV light and any magnification lenses can scan across an area in which the fluorescent substance is being sought. If a fluorescent substance is present, the UV Glasses or UV Face Shield can detect the fluorescent substance for the wearer.

There are a number of applications in areas of life for which the UV Glasses and/or the UV Face Shield may be useful for finding fluorescent substances, such as without limitation:
a) Travel:
   Bodily fluids on linens, floors, bathrooms—Wearers are able to check linens, bed coverings, floors, sinks, and bathrooms. Urine, semen, vaginal discharge, and vomit can be seen using the UV Glasses and/or UV Face Shield.
   Bed Bugs—The most common place to find bed bug eggs is on or near beds. They usually are found on the mattress seams and joints, but they can be commonly found on box springs and behind headboards.
b) Lice: The UV Glasses and/or UV Face Shield can be useful in finding lice, as well as the unhatched eggs and newly hatched eggs of lice. Illuminating the lice will help with removing the unhatched eggs to prevent the reappearance of lice.
c) Pest control:
   Many arthropods (insects, spiders, and relatives) glow under ultraviolet light. Scorpions and some relatives produce a glow due to molecules in their exoskeleton being fluorescent.
d) Pets: The UV Glasses and/or UV Face Shield can be used to detect dog and cat urine and vomit.
e) Homebuyers: The UV Glasses and/or UV Face Shield can be used to confirm that a new home is free from bacteria, urine, seminal fluids, blood, and vomit on carpet, walls, and highly touched areas. Mold or water damage can also be detected.
f) Home Care/Cleaning: The UV Glasses and/or UV Face Shield can help detect hidden pathogens on walls, high-touched areas, ledges, furniture, and scores of other surfaces. The UV Glasses and/or UV Face Shield cause materials such as bacteria, urine, seminal fluids, blood, and vomit to fluoresce. Mold or water damage can also be detected.
g) Commercial Cleaning: The UV Glasses and/or UV Face Shield can help detect hidden pathogens on walls, high-touched areas, ledges, furniture, and many other surfaces in commercial structures, such as stores, offices, and warehouses. The UV Glasses and/or UV Face Shield cause materials such as bacteria, urine, seminal fluids, and blood, and vomit to fluoresce. Mold or water damage can also be detected.
h) Automotive: The UV Glasses and/or UV Face Shield can detect manufactured fluorescent fluids, such as those used in vehicles, that may be leaking unintentionally.
i) Electrical: The UV Glasses and/or UV Face Shield can detect fluorescent wiring. In some applications, the detection can enable more efficient tracing of such fluorescent wiring in the midst of surrounding non-fluorescent wiring and structures.
j) Currency: Newer United States paper currency contains some fluorescent treads. Placement is different for each denomination, and the thread glows a unique color under a UV light. The thread in a $5 bill glows blue, a $20 bill thread glows green, and a $100 bill glows pink under the UV Glasses and/or UV Face Shield.
k) Forensics: Traces of blood and other bodily fluids and other fluorescent materials can be illuminated in forensic investigations and facilitate a quicker identification of such fluids.

### BRIEF DESCRIPTION OF THE DRAWINGS

FIG. 1 illustrates a schematic perspective view of a nonlimiting embodiment of UV light equipped eyeglasses (UV Glasses) according to the invention.

FIG. 2 illustrates a schematic top view of the UV Glasses of FIG. 1.

FIG. 3 is a perspective view of a second embodiment of the UV Glasses.

FIG. 4A is a perspective view of a third embodiment of the UV Glasses.

FIG. 4B is an enlarged portion of FIG. 4A, illustrating an embedded UV light in the UV

### Glasses.

FIG. 5A is a front view of a fourth embodiment of the UV Glasses.

FIG. 5B is an enlarged detail view of a front portion of the UV Glasses of FIG. 5A.

FIG. 5C is a side view of the UV Glasses of FIG. 5A.

FIG. 5D is a bottom view of the UV Glasses of FIG. 5A.

FIG. 5E is a bottom view of the UV Glasses of FIG. 5A connected to a charging assembly.

FIG. 6 is a perspective view of an embodiment of a UV light equipped face shield (UV Face shield).

### DETAILED DESCRIPTION OF THE PREFERRED EMBODIMENT

The Figures described above and the written description of specific structures and functions below are not presented to limit the scope of what Applicant has invented or the scope of the appended claims. Rather, the Figures and written description are provided to teach any person skilled in the art how to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present disclosure will require numerous implementation-specific decisions to achieve the developer's ultimate goal for the commercial embodiment. Such implementation-specific decisions may include, and likely are not limited to, compliance with system-related, business-related, government-related, and other constraints, which may vary by specific implementation, location, or with time. While a developer's efforts might be complex and time-consuming in an absolute sense, such efforts would be, nevertheless, a routine undertaking for those of ordinary skill in this art having benefit of this disclosure. It must be understood that the inventions disclosed and taught herein are susceptible to numerous and various modifications and alternative forms. The use of a singular term, such as, but not limited to, “a,” is not intended as limiting of the number of items. Further, the various methods and embodiments of the system can be included in combination with each other to produce variations of the disclosed methods and embodiments. Discussion of singular elements can include plural elements and vice-versa. References to at least one item may include one or more items. Also, various aspects of the embodiments could be used in conjunction with each other to accomplish the understood goals of the disclosure. Unless the context requires otherwise, the term “comprise” or variations such as “comprises” or “comprising,” should be understood to imply the inclusion of at least the stated element or step or group of elements or steps or equivalents thereof, and not the exclusion of a greater numerical quantity or any other element or step or group of elements or steps or equivalents thereof. The device or system may be used in a number of directions and orientations. The terms “top,” “up,” “upward,” “bottom,” “down,” “downwardly,” and like directional terms are used to indicate the direction relative to the figures and their illustrated orientation and are not absolute relative to a fixed datum such as the earth in commercial use. The term “coupled,” “coupling,” “coupler,” and like terms are used broadly herein and may include any method or device for securing, binding, bonding, fastening, attaching, joining, inserting therein, forming thereon or therein, communicating, or otherwise associating, for example, mechanically, magnetically, electrically, chemically, operably, directly or indirectly with intermediate elements, one or more pieces of members together and may further include without limitation integrally forming one functional member with another in a unitary fashion. The coupling may occur in any direction, including rotationally. The term “inner,” “inward,” “internal” or like terms refers to a direction facing toward a center portion of an assembly or component, such as longitudinal centerline of the assembly or component, and the term “outer,” “outward,” “external” or like terms refers to a direction facing away from the center portion of an assembly or component. The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions. Some elements are nominated by a device name for simplicity and would be understood to include a system of related components that are known to those with ordinary skill in the art and may not be specifically described. Various examples are provided in the description and figures that perform various functions and are non-limiting in shape, size, description, but serve as illustrative structures that can be varied as would be known to one with ordinary skill in the art given the teachings contained herein. As such, the use of the term “exemplary” is the adjective form of the noun “example” and likewise refers to an illustrative structure, and not necessarily a preferred embodiment. Element numbers with suffix letters, such as “a,” “b,” and so forth, are to designate different elements within a group of like elements having a similar structure or function, and corresponding element numbers without the letters are to generally refer to one or more of the like elements. Any element numbers in the claims that correspond to elements disclosed in the application are illustrative and not exclusive, as several embodiments may be disclosed that use various element numbers for like elements. Other embodiments are possible and the embodiments are only for illustrative purposes for principles of the invention.

The present invention comprises eyeglasses in combination with a UV light (UV Glasses) for hands-free ease of detection of fluorescent substances. The present invention also comprises a face shield in combination with a UV light (UV Face Shield). The UV Glasses and UV Face Shield are generally headwear devices that use the head to support the devices. One or more UV lights can be fixedly coupled to the eyeglasses or face shield and so configured to be synchronous with the wearer's head movement along with the wearer's vision to the area where the wearer is looking. In another embodiment, the UV light can be movably, including rotatably, coupled relative to the wearer's head movement in various planes to enable the wearer to adjust the area illuminated by the UV lights.

Table of Element Numbers in Figures.

| Ref. | Element |
|---|---|
| 2 | UV Glasses |
| 8 | Eyeglasses |
| 10 | Frame |
| 12 | UV Light |
| 14 | UV Emitter |
| 16 | Bridge |
| 18 | Rim |
| 20 | Lens |
| 22 | Temple |
| 24 | Screw |
| 26 | Hinge |
| 28 | Nose Piece |
| 30 | Temple End |
| 32 | Front End Piece |
| 34 | Top Bar |
| 36 | Coupling |
| 38 | Switch |
| 40 | Power Supply |
| 42 | UV Face Shield |
| 44 | Array Of UV Lights |
| 46 | Mounting Assembly |
| 48 | Face Shield |
| 50 | Charging Port |
| 52 | Charging System |
| 54 | Charging Connection |
| 56 | Charging Cord |
| 58 | Charging Splitter |
| 60 | Charging Power Supply |

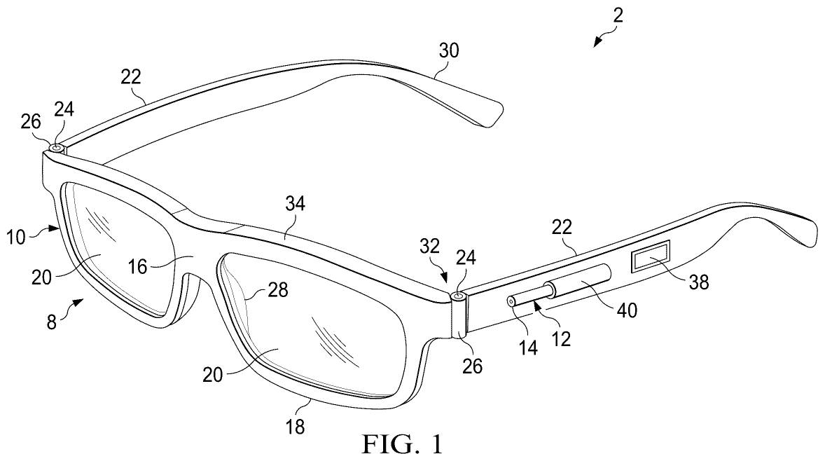

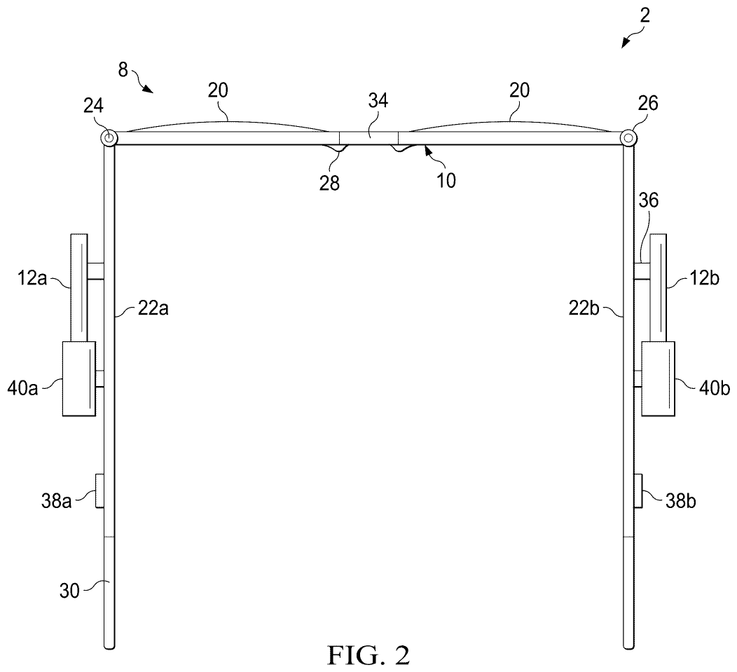

FIG. 1 illustrates a schematic perspective view of a nonlimiting embodiment of UV Glasses 2. FIG. 2 illustrates a schematic top view of the embodiment of FIG. 1. The UV Glasses can include eyeglasses 8 of various shapes and styles with one or more UV lights 12. The eyeglasses 8 comprise a frame 10 and lenses 20. The frame 8 generally comprises one or more rims 18 that provides a support structure for coupling the lenses 20. This coupling is anticipated to be through conventional means such as by fit, connectors, or adhesives. The forward portion of the frame 10 that rests in the front of the wearer's face has a top bar 34 that extends, at least partially, across the width of the wearer's face and may be part of the rims 18. Fitting above the wearer's nose is the bridge 16, which in conjunction with the nose pieces 28, help secure the eyeglasses 8 on the wearer's face. Generally, a pair of temples 22 are rotationally coupled at each front end piece 32 of the rim 18 top bar 34 by a hinge 26 and screw 24. The temples 22 extend back from the rims 18 over the wearer's ears and terminate at temple ends 30.

The UV light 12 comprises one or more UV emitters 14, such as a UV light bulb, a tuned LED, an emitter of a different wavelength with a UV filter, or another type of emitter. A power supply 40 is in operative communication with the UV light 12 to provide power to the UV light 12. A switch 38 may be in operative communication with the UV light 12 and power supply 40, so as to turn the UV light 12 on at one or more levels of intensity and off. The term “switch” is used broadly to include an actuator for circuit actuation, and can be manual or automatic through sensors, such as remote controlled, touch, movement or voice activated, and other methods known to those in the art of circuit actuation. The power supply 40 is generally a mobile energy storage device, and can include a mobile energy generator device, including without limitation, battery, rechargeable battery, solar panel, magnetic, or other power sources. The rechargeable battery can have a charging port 50 (shown in FIG. 5D), such as a USB port and other known charging options.

In at least one embodiment the UV light 12 can be coupled to the pair of eyeglasses 8, such as to the temples 22. The UV light 12 illuminates an area where the wearer is looking and can be fixedly mounted on the eyeglasses and move with corresponding movements of a wearer's head and therefore where the eyes will generally be directed. In other embodiments, the UV light 12 may be movably coupled and can be adjustably positioned in a variety of positions on or inside the eyeglasses 8. The coupling of the UV light 12 to the eyeglasses 8 may be accomplished in a variety of ways. A coupling 36 may be a fastener, an adhesive, clip, snap, hook and loop, or a variety of other mechanisms used for attaching items to each other. The UV light 12 can be coupled to the eyeglasses 8 after the eyeglasses 8 have been manufactured or integrated into the eyeglasses during manufacture.

It may be advantageous if the lenses have one or both of anti-UV lenses or have anti-UV coatings. Certain UV light is regarded as harmful to human eyes, therefore employing UV filter lenses (often called blue filter lenses) or UV coating (often called blue blocking coating) can help protect the wearer's eyesight while using the UV light. Often, this filtering is referred to as filtering the UV/A and UV/B light. Further, by filtering the undesired reflected light from the surface that is being illuminated by the fluorescent light, the UV filters can increase the possibility of finding the desired fluorescent substance.

Additionally, it may be advantageous if the lenses are tinted, such as yellow, red, or orange in color. Singly or combined, the anti-UV and yellow tinted lenses can allow the wearer to better view what is being revealed by the fluorescent light. When used in combination with a UV light, UV Glasses enable the wearer to more readily see traces of fluorescence. The different tints can work differently in varying conditions. In approximate terms, red lens eyeglasses can be configured to transmit 2% at 583 nm, yellow lens eyeglasses to transmit 2% at 480 nm, and orange lens eyeglasses to transit 2% at 549 nm.

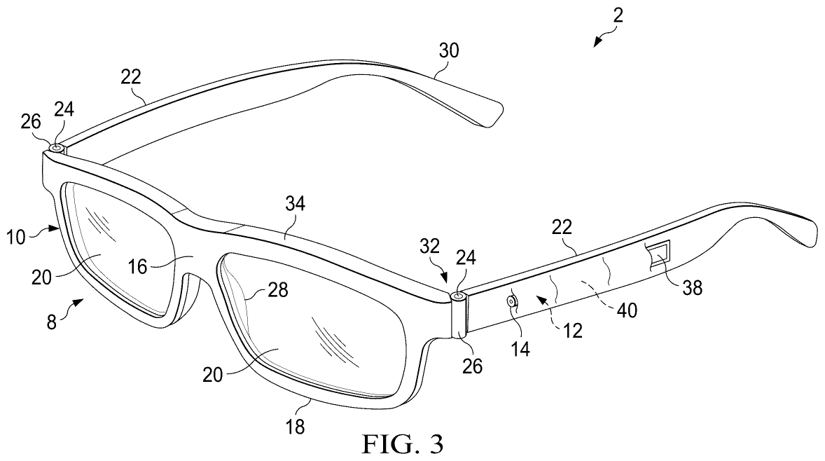

FIG. 3 is a perspective view of a second embodiment of the UV Glasses. In this embodiment, the UV light 12 is manufactured and incorporated into the eyeglasses 8, for example into the temples 22. The switch 38 and power supply 40 can also be incorporated into the frame 10, where the switch may be pressure activated and the power supply rechargeable, although other variations are possible. Other features can be similar to the first embodiment.

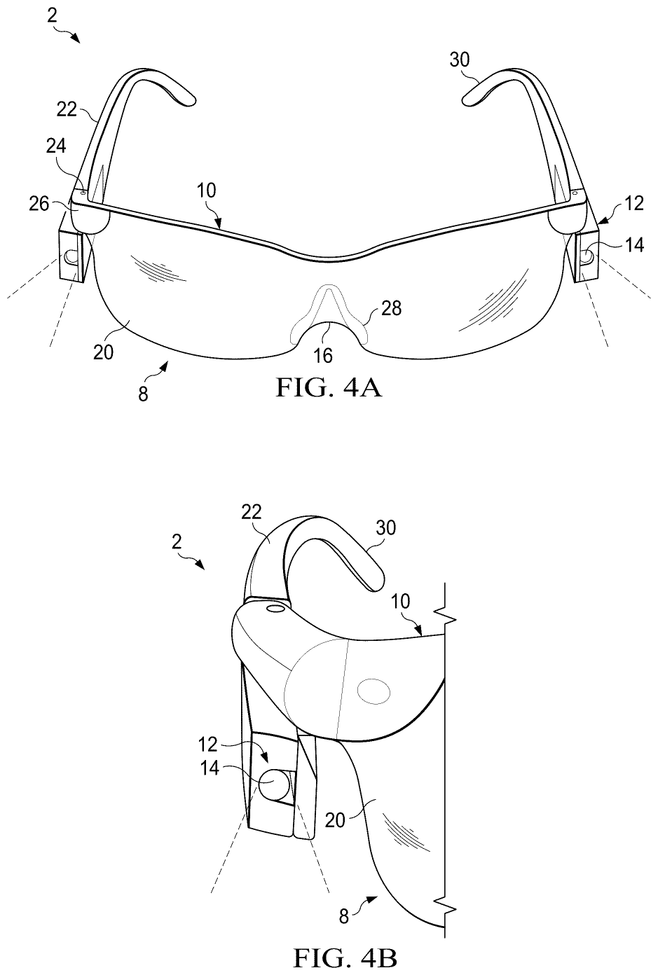

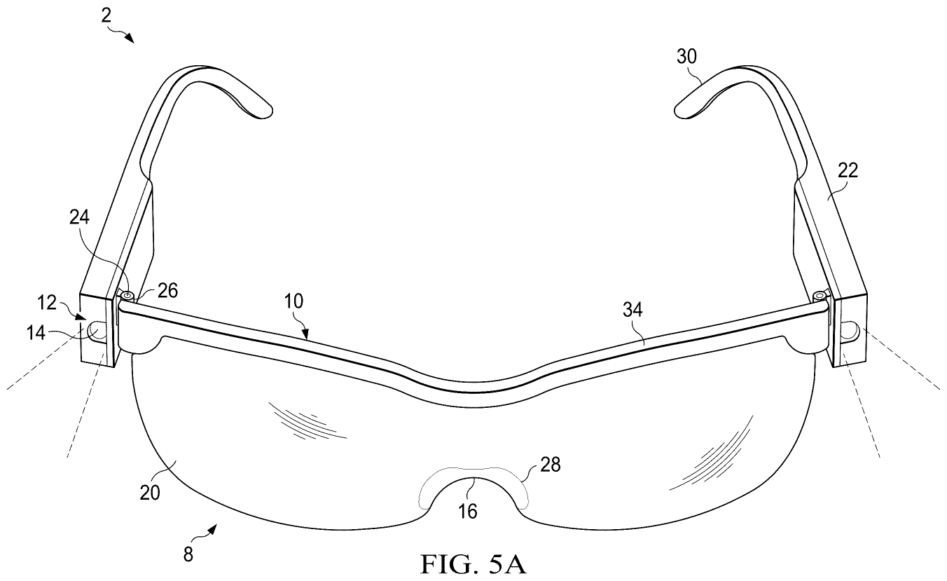

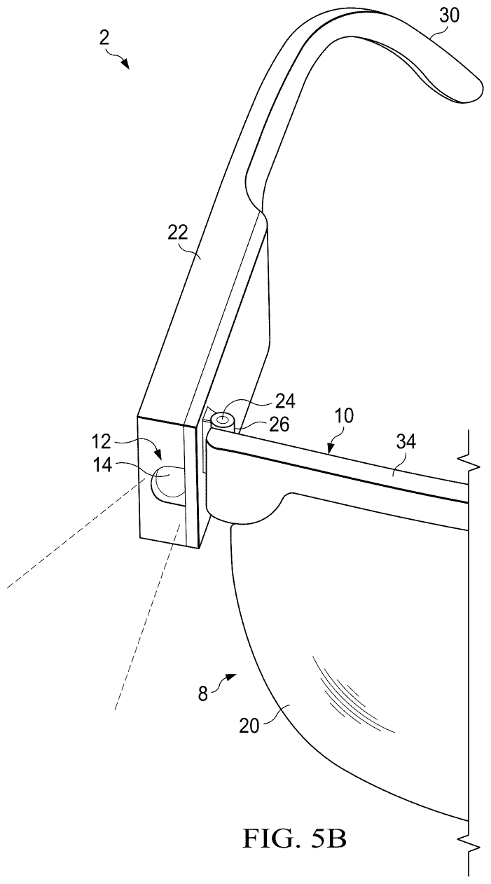

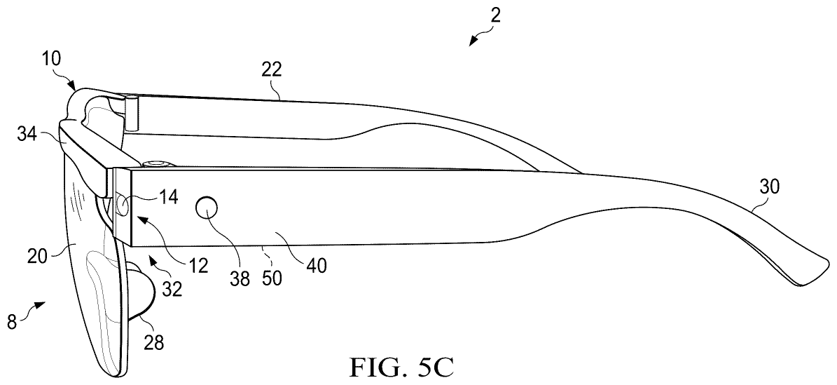

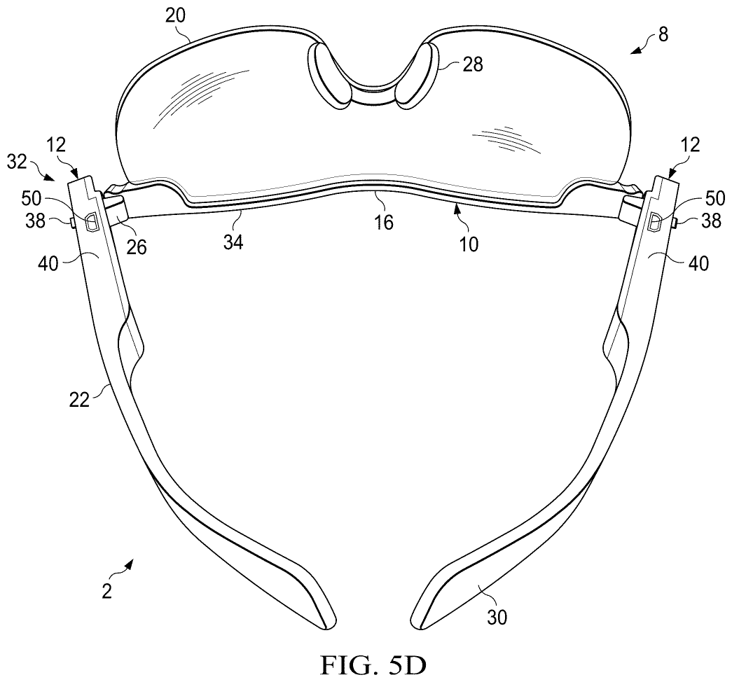

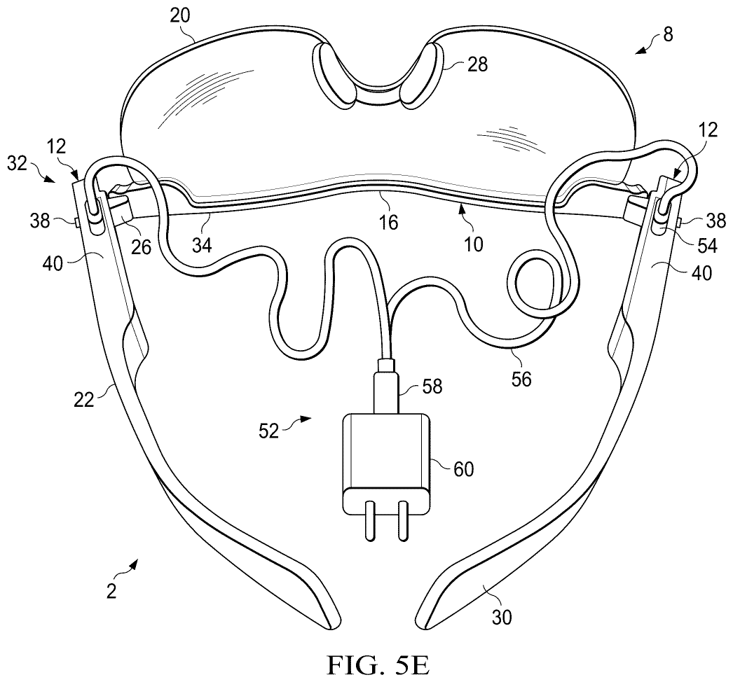

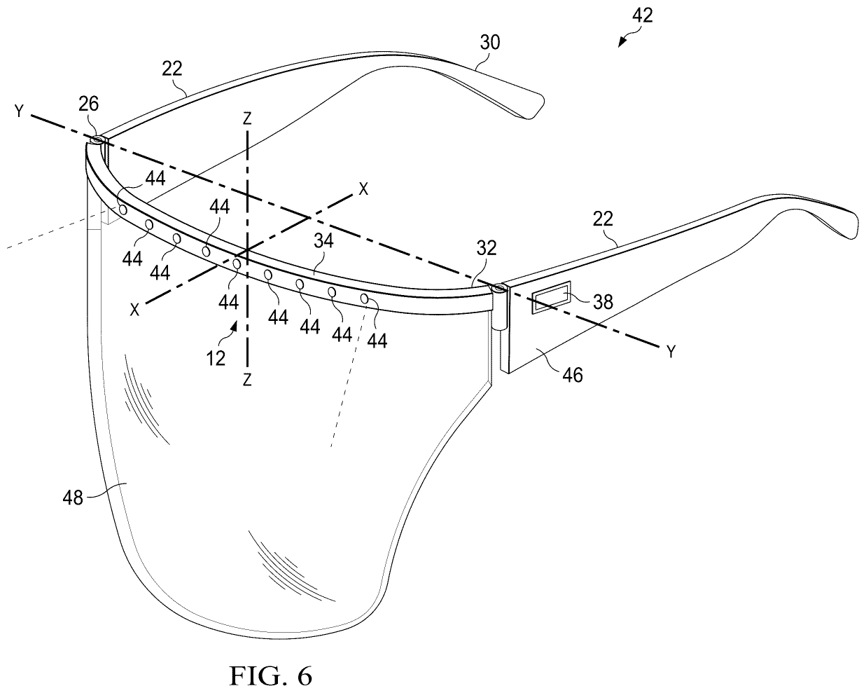

FIG. 4A is a perspective view of a third embodiment of the UV Glasses. FIG. 4B is an enlarged portion of FIG. 4A, illustrating an embedded UV light in the UV Glasses. The UV Glasses 2 includes a style of eyeglasses 8 referred to as rimless eyeglasses, where the lenses 20 are extended across a wearer's face and form the bridge 16 to which the nose piece 28 can be coupled. An outer portion of the lenses can be coupled to the hinges 26 for coupling the temples 22 to the lenses with screws 24. UV light 12 with a UV emitter 14 can be coupled into a thicker portion of the eyeglasses 8, such as a thicker portion of the temples 22, as shown.

FIG. 5A is a front view of a fourth embodiment of the UV Glasses. FIG. 5B is an enlarged detail view of a front portion of the UV Glasses of FIG. 5A. FIG. 5C is a side view of the UV Glasses of FIG. 5A. FIG. 5D is a bottom view of the UV Glasses of FIG. 5A. FIG. 5E is a bottom view of the UV Glasses of FIG. 5A connected to a charging assembly. Similar elements with the same numbers have been described above and can have different appearances with the same or similar function and need not be further described. In this exemplary embodiment, the UV Glasses 2 generally combine eyeglasses 8 with a frame 10 having a top bar 34 as in the first and second embodiments with the rimless lens 20 with the third embodiment for a partially rimless frame 8. Additionally, this embodiment can include a UV light 12 similar to the third embodiment in one or both of the temples 22. Further, this embodiment can include a rechargeable power supply 40 integrated into the temples 22 in this example with a charging port 50 electrically coupled with the rechargeable power supply 40 and accessible from outside the temple. Each rechargeable power supply 40 on each temple 22 can include a charging port. Alternatively, a single charging port 50 can be electrically coupled to the multiple rechargeable power supplies 40 in this example.

An exemplary charging system 52 can include a charging connection configured to engage the particular charging port, such as a USB or other port. A charging cord 56 can extend to a plurality of charging ports (such as the illustrated pair) from a charging splitter 58. The charging splitter can be removably coupled or integrated with a charging power supply 60. The charging power supply can be coupled to a system such as house current or itself contain a power source such as a relatively larger battery than the battery in the UV eyeglasses. In some embodiments, the rechargeable batteries can be charged by a wireless charger, also known as a touchless power station, by electromagnetic induction between a transmitter coil in the charger to a receiver coil in the UV Eyeglasses.

FIG. 6 is a perspective view of an embodiment of a UV light equipped face shield (UV Face Shield). The UV Face Shield 42 can protect the eyes, as does the UV Glasses embodiments described above, and additionally can protect the overall face of the wearer. The UV Face Shield 42 includes a face shield 48 coupled with one or more UV lights 12. The face shield 48 can be clear with no lenses or formed with embedded lenses (not shown) for magnification or even customized corrective vision. Further, a plurality of UV lights 12 can form an array 44 of UV lights. The term “array” is intended to mean a multiplicity of related items that are in an ordered series or arrangement. For example, the UV Face Shield can have an array 44 of UV lights 12 positioned across a top bar 34 coupled to the shield 48. The UV lights 12 can be arranged generally facing forward to direct emitted light in the direction the wearer is facing. Some UV lights 12 can be directed at an angle to the forward facing direction that allows a peripheral vision of the wearer to see fluorescing materials as well. Further, the UV lights 12 can be arranged at the sides of the face shield 48 in combination with the UV lights on the top bar or in lieu of such an array of UV lights similar to the UV Glasses embodiments. In some embodiments, one or more UV lights 12 can be directionally adjustable by the wearer to customize the viewing direction and/or angle of viewing. Finally, the UV lights 12 can be used in conjunction with more typical frequency lights and the switch 38 can control which lights that the wearer can choose to actuate.

The shield 48 can be held in place on the wearer by being coupled to a mounting assembly 46 that can include a nose bracket extending rearward from the shield toward the face. In one embodiment, the mounting assembly 46 can be comparatively rigid with the top bar 34 (or rim, not shown), temples 22, and temple ends 30, which use the head, the ears, or a combination to hold the UV Face Shield 42 on the wearer. In an alternative embodiment, the mounting assembly 46 may be less rigid, such as flexible strap (not shown) that can be adjustable and can be elastic.

The UV Face Shield 42 can be transparent and be clear or tinted with varying colors and varying degrees of light transmission through the shield 48. As used herein, an object that is “transparent” means the object has the property that light can pass through it such that a person can see through it. “Transparent” can include being tinted, while “clear” means generally transparent without any (noticeable to the wearer) color or tint.

The face shield 48 can be curved to generally at least partially cover a wearer's face from a side angle of some degree. For example, the face shield can be curved laterally (from side to side) generally along the Y-Y line and can be curved vertically (up and down) generally along the Z-Z line.

Regarding the sizing of the shield 48, it is anticipated that the shield and the mounting assembly 46 will be sized in a range designed to fit on or over a wearer's head and face. Thus, in an embodiment, the lateral distance of the shield along the Y-Y line may be in the range of five to eight inches, with an advantageous length of approximately six to seven inches. Likewise, the distance from the center of the top bar to a point even with the furthest end of the temple ends 30, along the X-X line, may be in the range of five to nine inches, with an advantageous length of approximately six to seven inches. In an embodiment, the length of the shield 48 from its top to its bottom near the center of the shield 48, along the Z-Z line, may be in the range of four to seven inches, with an advantageous length of approximately five to six inches.

Other and further embodiments utilizing one or more aspects of the inventions described above can be devised without departing from the disclosed invention as defined in the claims. For example, the shape of the eyeglasses and/or face shield can vary, the placement of the UV lights, the size and/or number of UV lights, variable UV intensity, multiple arrays and combinations of UV lights at various locations, and other contemplated variations can occur. Other variations than those specifically disclosed herein are within the scope of the claims.

The invention has been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicant, but rather, in conformity with the patent laws, Applicant intends to protect fully all such modifications and improvements that come within the scope of the following claims.

I claim:

1. A pair of UV Glasses comprising:
a pair of eyeglasses comprising magnifying lenses, and a temple;
wherein the lenses have a focal point from six (6) inches to four (4) feet of the lenses;
wherein the lenses are in the range of 1.0× to 10.0× magnification;
wherein the lenses are tinted yellow;
wherein the lenses filter UV light;
a UV light coupled to the temple, wherein a switch is in operable communication with the UV light such that the UV light can be turned on and off; and
a power supply coupled to the UV light.

2. A pair of UV Glasses comprising:
a pair of eyeglasses comprising one or more lenses coupled with one or more temples;
one or more UV lights coupled to the one or more temples, wherein a switch is in operable communication with the UV light such that the UV light can be turned on and off; and
one or more power supplies coupled to the UV lights.

3. The UV Glasses of claim 2, wherein the one or more lenses have a magnification in the range of 1.0× to 10.0× magnification.

4. The UV Glasses of claim 2, wherein the one or more lenses have a focal point from six inches to four feet.

5. The UV Glasses of claim 2, wherein the one or more lenses are tinted yellow, red, or orange.

6. The UV Glasses of claim 2, wherein the one or more lenses filter UV light.

7. The UV Glasses of claim 2, wherein the one or more lights are embedded in the one or more temples.

8. The UV Glasses of claim 2, wherein the one or more lights are movably coupled to the one or more temples.

9. The UV Glasses of claim 2, wherein the one or more power supplies are rechargeable.

10. A method of using the UV Glasses of claim 2, comprising:
placing the UV Glasses on a wearer's face;
turning on the UV light to produce a UV light beam;
moving the wearer's head such that the UV light beam is directed at an area; and
detecting a fluorescent substance if the fluorescent substance is present.

11. A UV Face Shield, comprising:
a translucent material forming a shield sized to protect a face of a wearer;
a mounting assembly coupled to the translucent material, the mounting assembly configured to support the translucent material on the wearer over the at least portion of the face;
one or more UV lights coupled to at least one of the translucent material and mounting assembly; and
a switch in operable communication with the one or more UV lights such that the UV lights can be turned on and off.

12. The UV Face Shield of claim 11, further comprising an array of UV lights coupled to the at least one of the translucent material and mounting assembly.

13. The UV Face Shield of claim 11, further comprising one or more UV lights coupled to the mounting assembly to shine from both sides of the face and move with movement of the face.
